(19) United States
(12) Patent Application Publication
(10) Pub. No.: US 2018/0021988 A1
(43) Pub. Date: Jan. 25, 2018

(54) MOULDS AND METHOD FOR MOLDING A PLASTIC SHEET

(71) Applicant: TOYOTA MOTOR EUROPE, Brussels (BE)

(72) Inventors: Tetsuya ODA, Toyota-shi (JP); Julien TACHON, Forest (BE)

(73) Assignee: TOYOTA MOTOR EUROPE, Brussels (BE)

(21) Appl. No.: 15/541,200

(22) PCT Filed: Jan. 21, 2015
(86) PCT No.: PCT/EP2015/051176

§ 371 Date: Jun. 30, 2017

(51) Int. Cl. B29C 43/36; B29C 70/46; B29C 51/30; B29C 45/14; B29C 51/08

(52) U.S. Cl. CPC B29C 43/361; B29C 45/1418; B29C 51/08; B29C 51/30; B29C 70/46; B29C 2043/3613; B29L 2031/003

(57) ABSTRACT

A mold for molding a plastic sheet having one or more angled portions, the mold including a mold cavity having at least one corner configured to produce the angled portion of the plastic sheet, and pressure modifying means positioned in proximity to the at least one corner, and configured to modify a pressure exerted on the angled portion during compression molding of the plastic sheet.

### FIELD OF THE DISCLOSURE

The present disclosure is related to the molding of objects, and more particularly to molding of plastic sheets.

### BACKGROUND OF THE DISCLOSURE

Molding of various plastic parts has been performed by various methods in the past, e.g., compression molding. Such molding typically involves a mold into which molten plastic material is provided and solidified to take the form of a cavity within the mold. Once solidified, the mold may be opened and the object having the shape of the cavity may then be removed.

In addition, starting materials, such as plastic sheets may be initially formed and then over-molded with an additional layer of plastic material, for example, a thermoplastic.

FIGS. 1A and 1B show an exemplary mold and process according to currently available systems used for such molding of plastic parts. As shown, such a mold typically includes two parts, a cavity part 1 and a core part 2 that when joined form a mold cavity 5 between them for compression molding plastic sheet 12.

Plastic sheet 12 may be preheated and introduced in between cavity part 1 and core part 2, and compression molded, i.e., compressed by closing the mold to cause plastic sheet 12 to be shaped according to mold cavity 5.

FIG. 1B shows the prior art mold 10 after a partial opening of the mold 10 to create a gap 9 for injection over-molding of a thermoplastic material onto the shaped sheet 12′. An injection nozzle 3 of the mold 10 enables the introduction of the molten plastic material 13 into mold cavity 5 for example, for the over-molding.

U.S. Pat. No. 3,153,813 describes vacuum molding machines for working on thermoplastic sheet material to form cup and other relief shapes therein which conform to mold contours where the molds may be either of the male type or the female or cavity type. However, systems such as these are not configured for an over-molding process.

U.S. Pat. No. 4,975,236 describes a method of shaping a thermoplastic sheet. The sheet is mounted on an articulated frame and pre-shaped by swinging hinged sections of the frame toward each other. A vacuum mold is then placed with its molded surfaces adjacent the pre-shaped sheet. Vacuum applied to the mold finally shapes the sheet.

### SUMMARY OF THE DISCLOSURE

It is a primary object of the disclosure to provide systems and methods for molding that overcome the deficiencies of the currently available systems and methods. Particularly, when compression molding plastic sheets (e.g., polypropylene or polyamide), using prior art molds such as those shown at FIGS. 1A and 1B, material located at angles on the part being molded are typically exposed to lower pressures. The inventors have recognized that this can cause poor consolidation and lack of resin on skin layers of the part. As a result, stress concentration is increased at these corners.

In addition, surface appearance is poor, particularly with fiber-reinforced plastic sheets, with a risk of dried fibers protruding at the surface. Such an issue can be more prevalent when a compression mold is separated by a desired distance to allow for over-molding of the shaped sheet with a layer of thermoplastic material. The present disclosure is therefore directed to maintaining suitable pressure at angled portions of the sheet formed at corners of the mold while compression molding, and also to maintaining structural integrity of a part when the mold is separated prior to injection over-molding.

According to embodiments of the present invention, a mold for molding a plastic sheet having one or more angled portions is provided. The mold includes a mold cavity having at least one corner configured to produce the angled portion of the plastic sheet, and pressure modifying means positioned in proximity to the at least one corner, and configured to modify a pressure exerted on the angled portion during compression molding of the plastic sheet.

By providing such a mold, pressure at an angled portion formed during compression may be compensated such that an optimal pressure is applied. This in turn can reduce stress concentration at the angled portion and also improve surface appearance.

The mold may be for molding a fiber-reinforced plastic sheet. The fibers comprising the reinforcement may comprise chopped fibers and/or continuous fibers. Such fibers may be glass, carbon, a combination thereof, or any other suitable material and may be embedded in the sheet.

The pressure modifying means may be hydraulically actuated, for example, using oil. A piston may be provided as the pressure modifying means.

The pressure modifying means may be positioned in a core part, in a cavity part, or both the core part and the cavity part

A second pressure modifying means may be positioned opposite the first pressure modifying means within the mold cavity.

The pressure modifying means may be configured to exert a positive pressure on the fiber reinforced sheet during compression molding, particularly, on the angled portion.

The pressure modifying means may be configured to exert a negative pressure on the plastic sheet following the compression molding, particularly, on the angled portion. By applying a negative pressure to the shaped plastic sheet, pull-away of the shaped plastic sheet may be reduced and even eliminated. Therefore, the shaped plastic sheet may hold a desired shape in advance of over-molding.

The mold may include an injection nozzle configured to introduce a molten thermoplastic material into the mold cavity following compression molding of the plastic sheet.

A plurality of pressure modifying means may be provide along with one or more valve means configured to selectively modify a force exerted by each of the plurality of pressure modifying means.

According to further embodiments of the present disclosure, a method for molding a plastic sheet, having one or more angled portions is provided. The method includes preheating the plastic sheet and modifying a shape of the plastic sheet by closing a compression mold to form at least one angled portion. During the compression molding, a force exerted on the at least one angled portion is increased over the force exerted on a remainder of the plastic sheet.

By providing such a method, it is possible to compensate for uneven pressures present on angled portions during compression molding. Therefore, stress concentration at corners may be reduced and surface appearance improved.

The method is preferably directed to molding a fiber-reinforced plastic sheet.

The method may include applying a negative pressure to the at least one angled portion during opening of the compression mold.

According to some embodiments, the method may include over-molding the shaped plastic sheet, for example, with a thermoplastic material, after the compression molding.

The over-molding may be performed by injection molding within the compression mold.

Prior to the over-molding, a negative pressure may be applied to the at least one angled portion during enlargement of a mold cavity formed by the compression mold, for example, during partial opening of the mold, wherein the enlarging is performed, for example, by separating two or more parts of the compression mold. By applying such a negative pressure, pull-away of the shaped plastic sheet may be limited and even avoided completely.

The increased force may be exerted on the core of the at least one angled portion.

According to still further embodiments of the present disclosure, a mold for molding a plastic sheet having one or more angled portions is provided. The mold includes a mold cavity having at least one corner configured to produce the angled portion of the plastic sheet, and a piston positioned in proximity to the at least one corner. The piston is configured to modify a pressure exerted on the angled portion during compression molding of the plastic sheet.

The piston may be hydraulically actuated.

The piston may be positioned in the core part.

The piston may be positioned in the cavity part.

According to some embodiments, a second piston positioned is provided opposite the first piston.

The piston may be configured to exert a positive pressure on the fiber reinforced sheet during compression molding.

The piston may be configured to exert a negative pressure on the plastic sheet following the compression molding.

The mold may include an injection nozzle configured to introduce a molten thermoplastic material into the mold cavity following compression molding of the plastic sheet.

A plurality of pistons and one or more valves configured to selectively modify a force exerted by each of the plurality of pistons may be provided.

It is to be understood that, except in cases of clear incompatibility and unless otherwise stated, features of one embodiment or example described herein can similarly be applied to other embodiments or examples described herein.

Other features and advantages of the disclosure will become apparent from the following detailed description, taken in conjunction with the accompanying drawings, which illustrate, by way of example, the principles of the disclosure.

It is to be understood that both the foregoing general description and the following detailed description are exemplary and explanatory only and are not restrictive of the disclosure, as claimed.

The accompanying drawings, which are incorporated in and constitute a part of this specification, illustrate embodiments of the disclosure and together with the description, serve to explain the principles thereof.

### BRIEF DESCRIPTION OF THE DRAWINGS

FIG. 1A shows a prior art mold configured for molding plastic sheets;

FIG. 1B shows the prior art mold of FIG. 1A following a partial opening of the mold and injection over-molding of a thermoplastic material;

FIG. 2A shows a mold configured for molding plastic sheets according to embodiments of the present disclosure;

FIG. 2B shows the mold of FIG. 2A during compression molding of a plastic sheet;

FIG. 2C shows the mold of FIG. 2A following partial opening of the mold to allow for injection of a thermoplastic material;

FIG. 2D shows the mold of FIG. 2A during injection over-molding of the plastic sheet; and

FIG. 3 is a block diagram showing exemplary steps for molding plastic sheets according to the present disclosure.

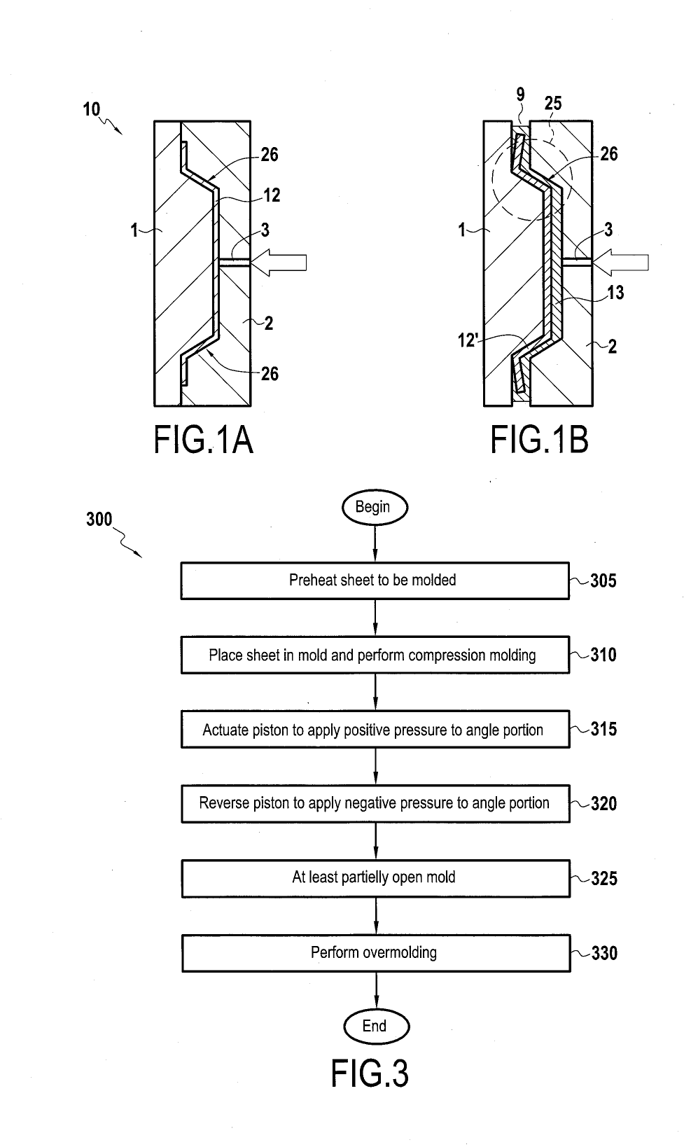

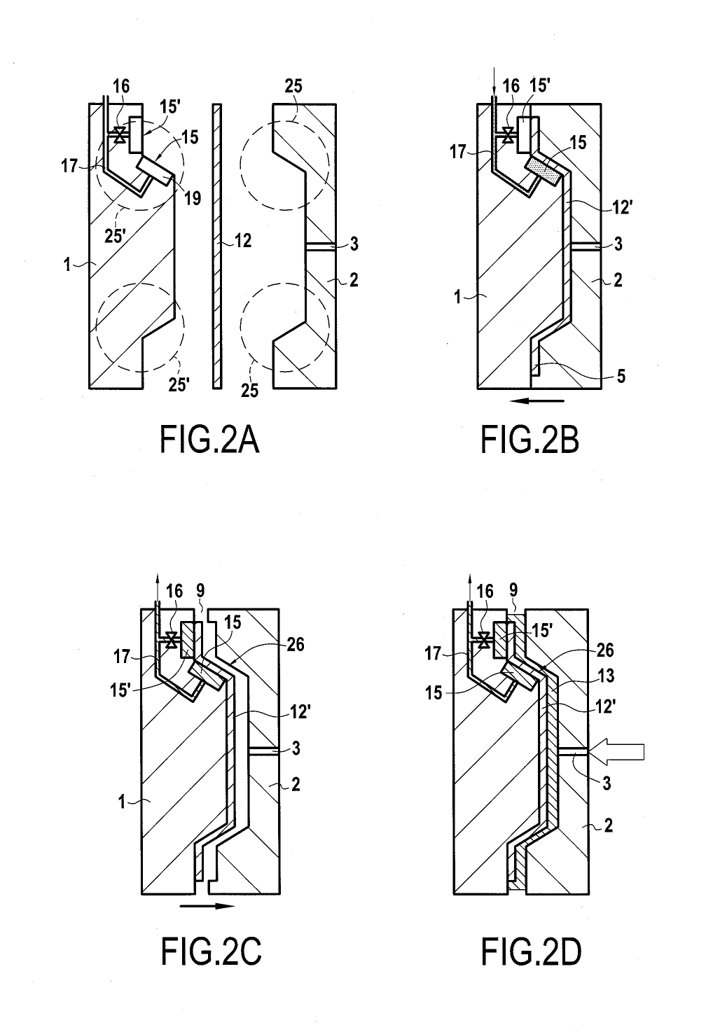

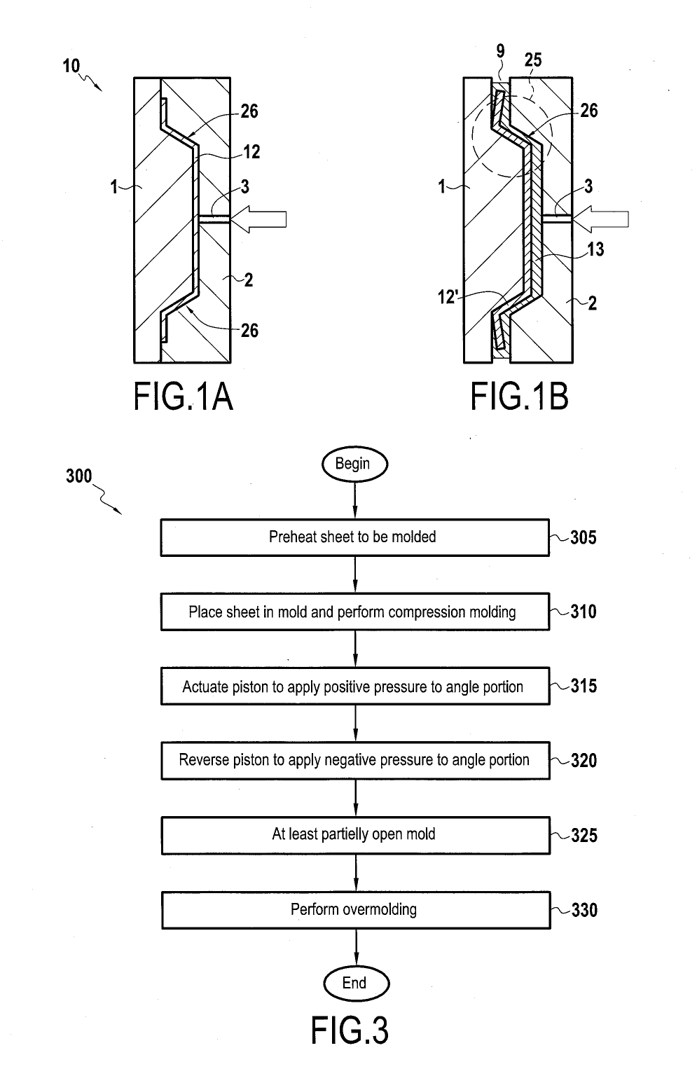

### DESCRIPTION OF THE EMBODIMENTS

Reference will now be made in detail to exemplary embodiments of the disclosure, examples of which are illustrated in the accompanying drawings. Wherever possible, the same reference numbers will be used throughout the drawings to refer to the same or like parts.

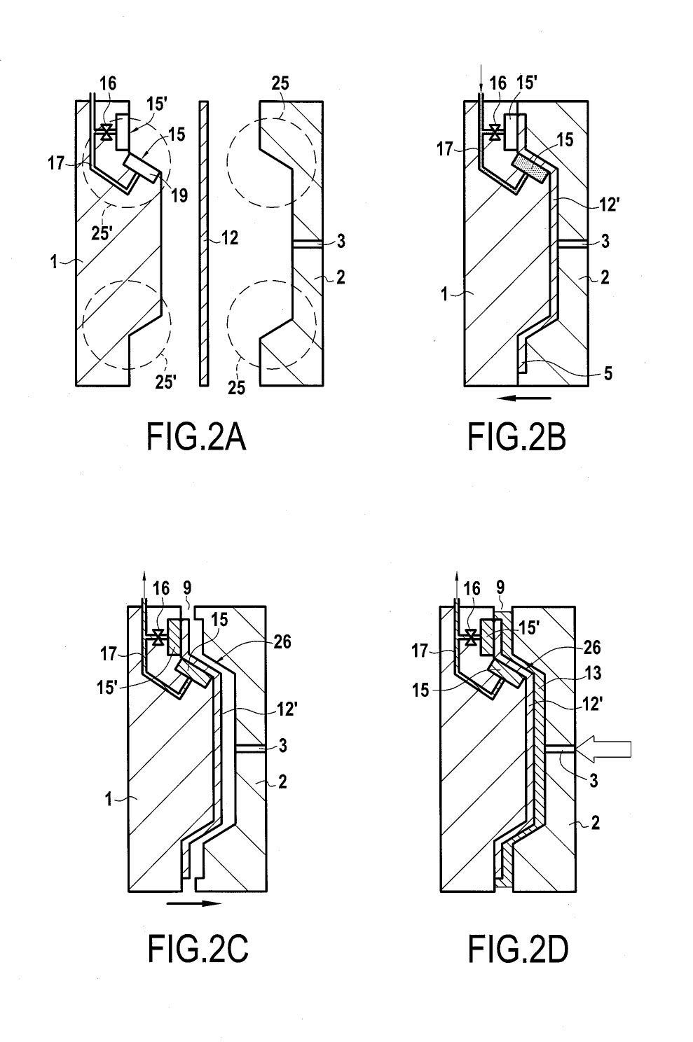

FIG. 2A illustrates an exemplary mold 10 according to embodiments of the present disclosure, mold 10 being configured to mold a plastic sheet 12 (e.g., a fiber-reinforced plastic sheet) having one or more angled portions 26. As shown in FIG. 2A, such a mold includes at least one injection nozzle 3, a cavity part 1, a core part 2, at least one corner 25, 25′ and one or more pressure modifying means 15, 15′.

Cavity part 1 and core part 2 are configured to be joined together to form a mold cavity 5 between them (shown occupied by plastic sheet 12 at FIG. 2B). According to some embodiments, mold cavity 5 may have a predefined space configured to exist between cavity part 1 and core part 2 when mold 10 is fully closed. For example, such a predefined space may be narrower than a thickness of a sheet 12 to be molded so as to provide compression when sheet 12 is inserted and mold 10 closed, thereby resulting in a shaped sheet 12′ following the compression molding.

Sheet 12 may be a plastic sheet (e.g., a thermoplastic) comprising, for example, polypropylene and/or polyamide such as PA6 (polyamide6), PA66 (polyamide 6,6) or aromatic polyamide. In addition, PPS (Polyphenylene sulfide) or PC (Polycarbonate) are also applicable, among others. In addition, sheet 12 may be reinforced with various materials, for example fibers. According to some embodiments, fiber reinforcement may comprise chopped and/or continuous fibers comprising, e.g., glass fiber, carbon fiber, etc. Such fibers may be embedded in sheet 12 to provide additional strength within sheet 12.

Cavity and core parts 1 and 2 may be formed from any suitable material capable of withstanding temperatures and pressures associated with compression and/or injection molding. For example, cavity and core parts 1 and 2 may be formed from aluminum and alloys thereof. Additionally, cavity and core parts 1 and 2 can each be of the same material or each may be a different material, as desired.

Surfaces associated with mold cavity 5 may be formed in one or more parts of cavity and core parts 1 and 2 by removing a portion material from one or more of cavity and core parts 1 and 2 so as to produce a cavity shape having at least one corner 25, 25′. Such removal may be performed by, for example, a milling machine (e.g., computer numerical control (CNC) milling in conjunction with computer aided drafting (CAD) tools), or other suitable devices. Alternatively, surfaces of mold cavity 5 may be formed by way of a stamping process, forging process, die-casting, or other process configured to result in at least one corner 25, 25′ configured to form an angled portion 26 in sheet 12 when cavity and core parts 1 and 2 are closed together (i.e., during compression molding).

Cavity part 1 and core part 2 may optionally include elements for maintaining and/or changing a temperature of mold 10, as well as sensors for monitoring said temperature. For example, one or more heating elements and/or cooling elements may be provided with mold 10 as desired, and sensors may be provided and configured to send data to a monitoring and/or automating apparatus (e.g., a computer system).

In addition to shaping mold cavity 5 as described above, additional features for pressure modifying means 15, 15′ may be provided within cavity part 1 and/or core part 2. For example, one or more recesses configured to receive pressure modifying means 15, 15′ may be created in proximity to one or more corners 25. When referring to “proximity to the corners” with regard to pressure modifying means 15, 15′, it is intended to mean that at least a portion of a surface of pressure modifying means 15, 15′ is located within a distance equal to twenty percent (20%) of a width of the surface of pressure modifying means 15, 15′ of the corner's 25 vertex.

According to some embodiments, it may be desirable to position pressure modifying means 15, 15′ on cavity part 1 only. This may be particularly true where a high quality surface finish is desired, because applying pressure to only one side can result in higher quality finish on the side where pressure is not applied. Alternatively, pressure modifying means may be positioned on core part 2 only, on cavity part 1, or both. When surface finish is a particular concern it may be preferably positioned on cavity part 1.

In addition, one or more channels 17 (e.g., fluid passages) and/or one or more valves 16 may be provided within cavity part 1 and/or core part 2 for enabling control of pressure modifying means 15, 15′. One of skill will recognize that more or fewer features may be provided in cavity and/or core parts 1 and 2 as desired for a particular implementation of pressure modifying means 15, 15′, the features discussed herein being exemplary only.

Pressure modifying means 15, 15′ may be configured to modify a pressure exerted on angled portion 26 of sheet 12 during and/or after compression molding of the fiber-reinforced sheet. For example, pressure modifying means 15, 15′ may be configured to exert a positive pressure (i.e., increased pressure) on sheet 12 (e.g., at angled portion 26) during compression molding, and, where desirable, a negative pressure on sheet 12 (e.g., at angled portion 26) during separation of cavity part 1 and core part 2.

Pressure modifying means 15, 15′ may, therefore, be implemented using various configurations. For example, pressure modifying means may be implemented as a hydraulically or pneumatically actuated piston 19, such that piston 19 may move toward sheet 12 (i.e., to increase pressure on a portion of sheet 12) and away from sheet 12 (i.e., to decrease pressure on a portion of sheet 12) based on a pressure in a conduit 17 supplying fluid (e.g., hydraulic oil) or gas (e.g., air) to pressure modifying means 15, 15′. In such an example, one or more valves 16 may be provided such that pressure exerted by piston 19 may be controlled. Alternatively, an electro-mechanical actuated piston 19 may be provided. In such a case, channels 17 may be replaced with electrically conductive material (e.g., one or more wires) which is insulated from material of mold 10. Such electrically conductive materials may be switched, for example, in order to control actuation of different pressure modifying means, as desired.

According to some embodiments, valves 16 may be configured to allow operation of different pressure modifying means 15, 15′ at different times during a molding process. For example, as shown at FIG. 2B, during compression molding of sheet 12, valve 16 may be closed thereby preventing actuation of pressure modifying means 15′. In this way, positive pressure may be maintained at angled portion 26 by pressure modifying means 15, but no modified pressure is applied at pressure modifying means 15′.

Following compression molding, as shown at FIG. 2C, valve 16 may be opened, and a negative pressure applied to channels 17. Therefore, a negative pressure may be applied to shaped sheet 12′ at both pressure modifying means 15 and 15′, thus causing a “holding force” on shaped sheet 12′ at angled portion 26. Therefore, an integrity of angled portion 26 may be better maintained by way of holding shaped sheet 12′ to either cavity part 1 or core part 2. One of skill in the art will recognize that more or fewer valves 16 may be provided and opened/closed as desired to obtain an effect as described herein.

Regardless of the type and number of pressure modifying means provided with mold 10, one of skill may desire to implement one or more sensors configured to sense a pressure exerted by piston 19. Such sensors (not shown) may be located, for example, in piston 19, cavity part 1, core part 2, and/or other suitable locations.

Various techniques may be employed for manipulating cavity part 1 and core part 2 in order to accomplish opening and closing of mold 10. For example, each of cavity and core parts 1 and 2 may be supported by a distinct platen (not shown), which may in turn be linked to a motive mechanism (e.g., a hydraulic press). Upon actuation of the hydraulic press, cavity part 1 and core part 2 are caused to either come together to “close” the mold and begin compression molding, or to move away from one another to “open” the press at least partially, for example, to form gap 9 allowing space for an injection over-molding to take place following compression molding. In such an exemplary configuration, one or both of the platens may be movable. According to some embodiments, a bottom platen moves towards a stationary top platen. One of skill in the art will recognize that other configurations may be implemented as desired.

As shown at FIG. 2D, injection nozzle 3 is configured to provide a molten material (e.g., molten plastic) to mold cavity 5 (i.e., into gap 9) during an injection over-molding process. Therefore, injection nozzle 3 may comprise a channel within cavity and/or core parts 1 and 2, this channel being configured for fluid communication with a provider of molten material (not shown). The molten material injected via injection nozzle 3 may comprise at least a desired thermoplastic material with which an object is to be over-molded, the plastic material being heated to a temperature exceeding its melting point. The molten material may further comprise, where desired, a foaming agent, among other things such as pigments, reflective elements, magnetic particles, etc. Importantly, while the various components of the injected material are described here with regard to FIG. 2D, such components may be applicable and utilized with any molding system and method falling within the scope of the present disclosure.

FIG. 3 is a block diagram 300 showing exemplary steps for molding plastic objects according to the present disclosure. Such steps may be carried out using molds according to embodiments of the present disclosure.

A sheet 12 (e.g., a fiber-reinforced plastic sheet) to be molded may initially be preheated, for example, by heating elements provided in mold 10, and/or by a separate device (e.g., an oven) configured to preheat material (step 305)

Once sheet 12 has reached a desirable preheated temperature, cavity part 1 and core part 2 may be brought together, i.e., closed, around sheet 12 so as to effect a compression molding beginning the shaping of shaped sheet 12′ (step 310).

During the compression molding of sheet 12, one or more pressure modifying means 15, 15′ may be actuated to apply a positive pressure to an angled portion 26 formed in sheet 12 by compression molding in mold 10, e.g., by way of one or more corners 25 (step 315). For example, fluid pressure in channel 17 may be increased and valve 16 closed so as to drive piston 19 toward sheet 12, thereby increase pressure at angled portion 26.

Once compression molding has completed and sheet 12 molded into shaped sheet 12′, a negative pressure (i.e., a vacuum) may be applied to angled portion 26 (step 320). For example, fluid pressure in channel 17 may be decreased so as to cause retraction of piston 19 of pressure modifying means 15.

In addition, valve 16 may be opened such that negative pressure is also applied via pressure modifying means 15′. Such negative pressure may therefore, cause shaped sheet 12 to remain in contact with cavity part 1 or core part 2, depending on placement of pressure modifying means 15, 15′.

With negative pressure desirably applied to angled portion 26, cavity part 1 and core part 2 may be at least partially separated to create a desired gap 9 to enable space for over-molding (step 325). For example, a platen supporting cavity part 1 may be actuated so as to separate a predetermined distance from core part 2, thereby forming gap 9 into which molten plastic material may be injected for over-molding shaped sheet 12′.

A molten material can then be provided to mold cavity 5 so as to over-mold shaped sheet 12′ (step 330). This molten material may comprise for example, molten plastic and, where desired, a foaming agent or other suitable substance (e.g., pigments, reflective materials, magnetic materials, etc.) The molten material may be provided via injection nozzle 3 and may be provided under varying levels of pressure to facilitate injection. Further, the providing may be performed at a rate permitting a temperature gradient within the material during and immediately following the providing to be minimized.

Further, the material can be provided to mold cavity 5 in a quantity calculated to permit a desired coverage of shaped sheet 12′ based on the separation created between cavity part 1 and core part 2 of mold 10.

Embodiments of the present disclosure enable compression molding of angled portions of a part having better consolidation, more resin at a skin layer, and therefore, better integrity overall. In other words, a higher quality part may be produced.

Throughout the description, including the claims, the term “comprising a” should be understood as being synonymous with “comprising at least one” unless otherwise stated. In addition, any range set forth in the description, including the claims should be understood as including its end value(s) unless otherwise stated. Specific values for described elements should be understood to be within accepted manufacturing or industry tolerances known to one of skill in the art, and any use of the terms “substantially” and/or “approximately” and/or “generally” should be understood to mean falling within such accepted tolerances.

Where any standards of national, international, or other standards body are referenced (e.g., ISO, etc.), such references are intended to refer to the standard as defined by the national or international standards body as of the priority date of the present specification. Any subsequent substantive changes to such standards are not intended to modify the scope and/or definitions of the present disclosure and/or claims.

Although the present disclosure herein has been described with reference to particular embodiments, it is to be understood that these embodiments are merely illustrative of the principles and applications of the present disclosure.

For example, the step of over-molding described above may be omitted, particularly where desirable to have a compression molded part only.

It is intended that the specification and examples be considered as exemplary only, with a true scope of the disclosure being indicated by the following claims.

1-10. (canceled)

11. A method for molding a plastic sheet having one or more angled portions, the method comprising:
preheating the plastic sheet; and
modifying a shape of the plastic sheet by closing a compression mold to form at least one angled portion, wherein, during the compression molding, a force exerted on the at least one angled portion is increased over the force exerted on a remainder of the plastic sheet.

12. The method according to claim 11, comprising applying a negative pressure to the at least one angled portion during opening of the compression mold.

13. The method according to claim 11, comprising over-molding the shaped plastic sheet, for example, with a thermoplastic material, after the compression molding.

14. The method according to claim 13, wherein the over-molding is performed by injection molding within the compression mold.

15. The method according to claim 13, wherein prior to the over-molding, a negative pressure is applied to the at least one angled portion during enlargement of a mold cavity formed by the compression mold, wherein the enlarging is performed, for example, by separating of the compression mold.

16. The method according to claim 11, wherein the increased force is exerted on the core side of the at least one angled portion.

17. A mold for molding a plastic sheet having one or more angled portions, the mold comprising:
a mold cavity having at least one corner configured to produce the angled portion of the plastic sheet;
a piston positioned in proximity to the at least one corner, and configured to modify a pressure exerted on the angled portion during compression molding of the plastic sheet.

18. The mold of claim 17, wherein the piston is hydraulically actuated.

19. The mold of claim 17, wherein the piston is positioned on a core part.

20. The mold of claim 17, wherein the piston is positioned on a cavity part.

21. The mold of claim 17, further comprising a second piston positioned opposite the first piston within the mold cavity.

22. The mold of claim 17, wherein the piston is configured to exert a positive pressure on the fiber reinforced sheet during compression molding.

23. The mold of claim 17, wherein the piston is configured to exert a negative pressure on the plastic sheet following the compression molding.

24. The mold of claim 17, wherein the mold comprises an injection nozzle configured to introduce a molten thermoplastic material into the mold cavity following compression molding of the plastic sheet.

25. The mold of claim 17, comprising a plurality of pistons and one or more valves configured to selectively modify a force exerted by each of the plurality of pistons.
